(19) United States
(12) Patent Application Publication
(10) Pub. No.: US 2013/0280314 A1
(43) Pub. Date: Oct. 24, 2013

(54) FIBERGLASS INSULATION TREATED WITH A PESTICIDE

(71) Applicant: PEST CONTROL INSULATION, LLC, Homer, GA (US)

(72) Inventors: Brandon P. Ansley, Atlanta, GA (US); William N. Turk, Demorest, GA (US); John A. Mancin, IV, Gainesville, GA (US); John D. Elliot, Charlotte, NC (US)

(73) Assignee: Pest Control Insulation, LLC, Homer, GA (US)

(21) Appl. No.: 13/866,377

(22) Filed: Apr. 19, 2013

Related U.S. Application Data
(60) Provisional application No. 61/635,747, filed on Apr. 19, 2012.

(51) Int. Cl. E04B 1/72; B05D 7/00

(52) U.S. Cl. CPC E04B 1/72; B05D 7/00
USPC 424/412; 424/659; 427/212

(57) ABSTRACT

A system including fiberglass insulation that is treated with a pesticide is disclosed. The system can provide pest control for structures in which it is installed. The pesticide is applied to the fiberglass insulation in sufficient quantities to provide pest control. The pesticide is also applied to the insulation such that it is bioavailable, yet remains on the insulation during manufacturing, transportation, installation, and a significant period thereafter. The pesticide is applied such that it is bioavailable, i.e., a lethal dose of pesticide is provided to pests that come into contact with the insulation.

### CROSS REFERENCE TO RELATED APPLICATIONS

This application claims priority to and benefit under 35 USC §119(e) of U.S. Provisional Patent Application Ser. No. 61/635,747, of the same title, filed Apr. 19, 2012, which is hereby incorporated by reference as if fully set forth below.

### BACKGROUND OF THE INVENTION

1. Field of the Invention

Embodiments of the present invention relates generally to treated insulation, and more specifically to fiberglass insulation treated with a pesticide.

2. Description of the Related Art

Most buildings in the U.S. (particularly residential structures) and many abroad require some form or type of thermal insulating material. This thermal insulating material (hereinafter “insulation”) is most often installed around the structure's habitable area so that the temperature of that area can be maintained and kept reasonably comfortable, i.e., so that conditioned air can be kept inside the structure and hot or cold non-conditioned air out of the structure. The most common types of insulation in the U.S. are fiberglass, cellulose, foam, and mineral wool (or, rockwool).

In the simplest of terms, insulation works by providing a layer of material, which contains significant air space, that slows down (or “resists”) heat transmission, thereby helping to keep conditioned air inside a structure and/or the unconditioned air out of the structure. As shown in FIG. 1, the combined areas/locations in and around a structure in which the insulation is generally installed is commonly referred to as the structure's “thermal envelope.”

Buildings the world over, but particularly in the southern U.S., require treatment with some sort of pesticide or other form of pest control to protect the structure from wood destroying organisms (such as termites and carpenter ants) and to help keep insects, including those considered “household pests” by the pest control industry, out of the structure. Over 20 percent of all single family homes in the U.S. that are owned by individuals making over $60,000 per year, for example, are under contract with a professional pest management company to help keep pests out of their home.

Because the “thermal envelope” represents an existing barrier for the structure, it would be advantageous to use this barrier for multiple purposes. In other words, the thermal barrier that seeks to keep unconditioned air out of a structure could also be used to keep unwanted pests out of the structure. Unfortunately, there are many challenges to creating an insulation product that is also a pesticide.

On problem is that the product obviously must be effective in killing the targeted pests. Two important characteristics for efficacy are: 1) dosage and 2) presentation. Dosage relates to the amount of pesticide that is available. Presentation relates to the “bio-availability” to the targeted insects.

In terms of dosage, there must be enough of the pesticide in the insulation to kill the targeted pests over a predetermined time. Thus, while a pesticide may be present in the insulation, it must be present in high enough quantities to achieve a kill on the targeted pest.

Insufficient quantities of a pesticide can fail required efficacy testing and may not be able to attain the required EPA or state certifications.

In addition to the correct dosage in the insulation to kill a targeted pest, the pesticide must be presented to a targeted pest in a manner that allows for ingestion (or contact, depending on the killing mechanism of the pesticide) by the pest. In other words, it must be “bioavailable” to the targeted pests. The pesticide should be presented in a way that a pest transfers the pesticide to the pest's body (e.g., to their exoskeleton). In this manner, the pest can later ingest the pesticide and/or transfer the pesticide to, for example, other pests and the nest. This is the most challenging aspect of treating an insulation product with a pesticide.

Conventional products exist, for example, that provide antifungal protection for certain types of insulation. The backing paper for traditional fiberglass insulation may include antifungal or pesticidal agents, for example, to provide resistance to mold, mildew, or insect damage. This does nothing, however, to prevent insects, or other unwanted organisms (hereinafter, “pests”) from entering the dwelling. In other words, providing active pesticide ingredients to kill pests that may attempt to eat the insulation, for example, does not have to be provided at the same level, or dosage, and with the same bioavailability as that required to kill pests as they pass over the insulation. In industry terms, it can be likened to the difference between a “treated article” and a pesticide—the former protects the article from damage, the latter protects the habitable structure.

What is needed, therefore, is fiberglass insulation that is treated with a pesticide. The pesticide should be bioavailable in sufficient dosages to both deter and kill pests. The pesticide should be bioavailable in sufficient dosages to protect the structure from pests, not just the insulation. It is to such insulation that embodiments of the present invention are primarily directed.

### BRIEF SUMMARY OF THE INVENTION

Embodiments of the present invention relates generally to treated insulation, and more specifically to fiberglass insulation treated with a pesticide. Embodiments of the present invention can comprise a system including fiberglass insulation that is treated with a pesticide is disclosed. The system can provide pest control for structures in which it is installed. The pesticide can be applied to the fiberglass insulation, for example, in sufficient quantities to provide pest control. The pesticide can also be applied to the insulation such that it is bioavailable, yet remains on the insulation during manufacturing, transportation, installation, and a significant period thereafter. The pesticide can be applied such that it is bioavailable, i.e., a lethal dose of pesticide is provided to pests that come into contact with the insulation.

Embodiments of the present invention can comprise a system comprising insulation providing insulation for a predetermined portion of a structure, and a pesticide adhered to the insulation product such that the pesticidal product is bioavailable. In some embodiments, the system can provide pest control for at least the predetermined portion of the structure. In some embodiments, the predetermined portion of the structure comprises the thermal envelope of the structure and the system can provide pest control for the structure.

In some embodiments, the insulation can comprise a plurality of glass fibers. In other embodiments, the insulation can comprise a plurality of glass fibers combined with one or more of cellulose, foam, rock wool, and cotton. In some embodiments, the insulation can provide one or more of thermal, fire, or acoustical insulation.

In some embodiments, the pesticide can comprise boric acid. The pesticide can comprise, for example, between approximately 4-20% boric acid. In some embodiments, the pesticide can comprise 12.5% boric acid.

Embodiments of the present invention can also comprise a method of manufacture comprising providing a plurality of glass fibers, and applying a pesticide to the plurality of glass fibers such that the pesticide is bioavailable on the glass fibers. In some embodiments, the methods can further comprise heating the plurality of glass fibers until the plurality of glass fibers are at least partially molten prior to applying the pesticide to partially embed the pesticide in the glass fibers. In some embodiments, the pesticide can be mixed with a binder prior to applying the pesticide. The binder can comprise, for example and not limitation, phenolic resin, thermoplastic, thermosetting plastic, acrylic, or vinyl-acrylic. In some embodiments, the method can further comprise applying the pesticide to the plurality of glass fibers by dipping the plurality of glass fibers in the pesticide.

Embodiments of the present invention can also comprise a method comprising filling a blowing apparatus with a plurality of glass fibers, applying a pesticide to the plurality of glass fibers with the blowing apparatus, and blowing the plurality of glass fibers into a structure to provide insulation. In this configuration, the plurality of glass fibers can provide pest control for the structure.

In some embodiments, applying the pesticide to the plurality of glass fibers can comprise mixing the plurality of glass fibers with the pesticide in a hopper of the blowing apparatus prior to blowing the plurality of glass fibers into the structure. In other embodiments, applying the pesticide to the plurality of glass fibers can comprise spraying the plurality of glass fibers with the pesticide using one or more nozzles located in a hose of the blowing apparatus prior to blowing the plurality of glass fibers into the structure. In still other embodiments, applying the pesticide to the plurality of glass fibers can comprise spraying the plurality of glass fibers with the pesticide using one or more nozzles located at an outlet of a hose on the blowing apparatus as the glass fibers exit the blowing apparatus.

These and other objects, features and advantages of the present invention will become more apparent upon reading the following specification in conjunction with the accompanying drawing figures.

### BRIEF DESCRIPTION OF THE FIGURES

FIG. 1 is a perspective view of the combined areas/locations in and around a structure in which insulation is generally installed, commonly referred to as the structure's “thermal envelope.”

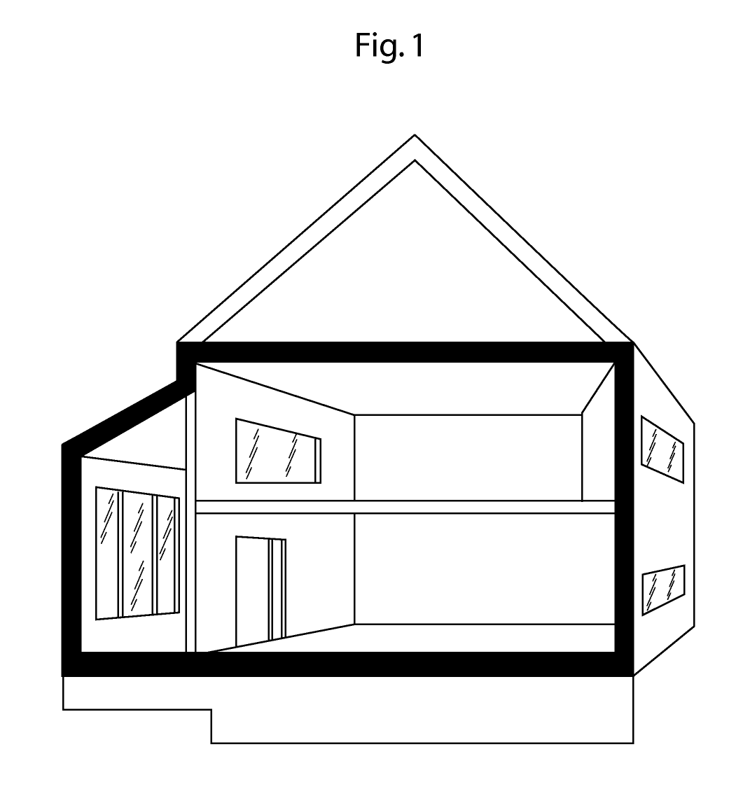

FIG. 2 depicts a blown insulation machine with mid-hose pesticide applicator, in accordance with some embodiments of the present invention.

FIG. 3 depicts a blown insulation machine with end-hose pesticide applicator, in accordance with some embodiments of the present invention.

FIG. 4 depicts a blown insulation machine with tip pesticide applicator, in accordance with some embodiments of the present invention.

FIG. 5 depicts an insulation assembly line conveyor with pesticide applicator, in accordance with some embodiments of the present invention.

### DETAILED DESCRIPTION OF PREFERRED EMBODIMENTS

Embodiments of the present invention relate to an insulation material comprising a pesticide. In some embodiments, the insulation can comprise fiberglass, for example, and can include a backing material such as, for example and not limitation, paper. The insulation can also comprise a pesticide, suitable for killing a plurality of pests, and provided at sufficient dosage and with sufficient bioavailability to effectively kill pests that contact the insulation.

To simplify and clarify explanation, the system is described below as fiberglass insulation with a pesticide. One skilled in the art will recognize, however, that the invention is not so limited. The system can also comprise other insulation materials such as, for example and not limitation, cotton, paper, and foam. Furthermore, while the system comprises a pesticide generally referred to below as a boric acid, other pesticides including, but not limited to, permethrin, cypermethrin, deltamethrin, pyrethroids, pyrethroid bifenthrin, fipronil, imidachloprid, botanicals, insect growth inhibitors, biopesticides or a combination of these could be used. In addition, various application and manufacturing techniques are described, but other suitable methods are contemplated.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention.

As described above, a problem with conventional treated insulation materials is that they do not contain chemicals at sufficient levels and with sufficient bioavailability to provide pest control for the dwelling. In other words, while some products may provide some beneficial chemicals (e.g., fungicides) that protect the insulation itself, for example, they do not provide pest control in the dwelling. In addition, the pesticides should be provided on the insulation in a manner that makes it bioavailable to pests. If the pesticide binds with the insulation such that it cannot adhere to, or be ingested by, the pest, for example, the dosage is irrelevant. At best, conventional products prevent pests from damaging the insulation itself, but do not protect the structure.

TAP Insulation, on the other hand, is an existing cellulose pest control insulation product with the active ingredient boric acid (H₃BO₃, orthoboric acid, 12.5%). The orthoboric acid is added to the cellulose insulation during the manufacturing process. Boric acid is advantageous as a pesticide because it performs a “mechanical kill” In addition, boric acid does not dissipate and has an extremely low mammalian toxicity. As a result, boric acid is an effective pesticidal ingredient, although others can be used in this invention and are contemplated herein.

The boric acid crystals adhere to the ground paper fibers, and although they “stick” to the paper fibers, they are able to easily detach from the fibers and be transferred to the targeted pests when the pest comes into contact with the insulation. Pests do not die from immediate contact with the insulation; rather, the boric acid attaches to the bodies of the pests as they crawl through or nest in it. Since the targeted pests are “self-grooming” insects, they ingest the boric acid when they groom themselves. As the pests cannot excrete the boric acid, it accumulates in the gut, eventually causing death due to dehydration, malnutrition, or both. The process described above is mechanical, so pests cannot build up a tolerance to it, as with organic or biological treatments.

The challenge to making a more effective fiberglass insulation product, however, is how to get the pesticide, or other chemical, adhered to the insulation in a form that will be both “bio-available” to targeted pests and at a concentration that is sufficient to kill the pest for an extended period of time. As used herein, “bioavailable” means that the pesticide is sufficiently adhered to the insulation, yet is easily detached when a pest comes into contact with the insulation. In this manner, the pesticide will remain adhered to the insulation during manufacturing, during installation, and for a predetermined time thereafter, yet can easily detach when contacted by a pest for maximum effectiveness.

Unlike cellulose, discussed above, the chemical composition of fiberglass does not allow for the same type semi-adhesion of the pesticide that cellulose does. In other words, fiberglass is an inorganic compound (essentially heated and expanded glass) and does not provide an effective surface on the molecular level for the boric acid to naturally adhere to.

What is needed, therefore, is a system and method for providing a fiberglass insulation material comprising a pesticide, or other useful chemical, that is provided at a sufficient dosage and with sufficient bioavailability to kill pests. The insulation should provide the pesticide in a manner such that the pesticide can be transferred from the insulation to the pest. In this manner, the pest can be eliminated and can also transfer the pesticide to the nest or other pests, for example. It is to such a system and method that embodiments of the present invention are primarily directed.

Embodiments of the present invention are related to a system and a method for creating a fiberglass insulation that is treated with a pesticide. In some embodiments, the fiberglass insulation can comprise, for example and not limitation, fiberglass or glass fibers. Fiberglass can include, for example, any insulation that contains any material that is made from heating glass (e.g., glass wool, blowing wool, etc.). This can include traditional fiberglass insulation that is mixed with, for example and not limitation, a cellulose-based product, a foam based product, or a cotton-based product. In some embodiments, the system can include a mixture of fiberglass, cellulose, foam, rock wool, cotton, other cloth materials, or any combination thereof.

In some embodiments, the system can also comprise a pesticide. Pesticide can include any substance, or mixture of substances, intended to prevent, destroy, repel, or otherwise mitigating pests as set forth in the Federal Insecticide, Fungicide, and Rodenticide Act (“FIFRA”). Insecticides can include, but are not limited to, boric acid or mixtures or forms of borates or boron, permethrin, cypermethrin, deltamethrin, pyrethroids, pyrethroid bifenthrin, fipronil, imidachloprid, botanicals, insect growth inhibitors, biopesticides, or a combination of these. Pests can include, for example and not limitation, insects, birds, mammals, rodents, marsupials, fungi, microbes, arthropods, and mites.

The system is described herein as a fiberglass insulation product with an incorporated pesticide regardless of whether the product will be registered as a pesticide by EPA, considered a “treated article,” or exempted from registration under FIFRA (i.e. treated with some pesticide substance or chemical that would not require registration).

Unlike additives that have been added to fiberglass insulation in the past that are added to protect or preserve the insulation itself, increase the insulating performance, or reduce harmful chemicals, for example, embodiments of the present invention relate to the addition of a pesticide into or onto a fiberglass insulation product for the purposes of conferring a pesticidal benefit to the structure in which the product is applied. In other words, the pesticide additive in this invention is not intended solely to protect the product itself from pests, but rather to help protect the structure in which it is installed from pests.

The application rates and concentrations can vary widely depending on, for example and not limitation, the pesticide used, the size of the dwelling, and the dwelling location (i.e., more pesticide would likely be required in the southern U.S. than in the northern U.S.). The application rate can be varied according to local needs. In some embodiments, if applying fipronil, for example, the molecule can be mixed with water at a rate of between 0.0500% and 0.0750% per gallon by weight. In some embodiments, fipronil can be mixed at a rate of 0.0625% per gallon by weight.

The fipronil/water mixture can then be applied to the glass fibers so that the measurable dried residue after application is be between approximately 50-75 ppm. In order to be efficacious against subterranean termites, for example, at least 1 ppm should be bioavailable to each passing organism to provide a kill Efficacy for each insect varies; however, a target of approximately 62 ppm provides effectiveness for a broad range of pests.

In other embodiments, if applying a liquid borate, such as BoraCare (a Nisus product that contains 40% disodium octaborate tetrahydrate), on the other hand, the pesticide can be mixed with water at approximately a 1:1 ratio and applied to the glass fibers so that the dried measurable residue would be between approximately 150,000-250,000 ppm. In some embodiments, the pesticide can be provided at approximately 230,000 ppm. In still other embodiments, if applying a dried, ground form of pure boric acid (e.g., orthoboric acid), the boric acid can be applied to the glass fibers at approximately 4-20% by weight.

The Pesticide can be added to the insulation, for example, during the manufacturing process, on the job site before installation of the insulation, or on the job site during the installation/application of the product, or some combination thereof.

In some embodiments, pesticide may be added to the insulation during the manufacturing process. The pesticide can be added during manufacture, for example, using a chemical binder or other form of “glue” or “adhesive.” In some embodiments, the adhesive can adhere the pesticide to the fiberglass in a manner suitable to prevent it from falling off during shipment and installation, yet remain bioavailable to pests that come into contact with the insulation. In some embodiments, the adhesive or binder can comprise, for example and not limitation, phenolic resin, thermoplastic, thermosetting plastic, acrylic, vinyl-acrylic, or other soluble polymer.

In other embodiments, the pesticide can be adhered to the fiberglass using, for example, static electricity (e.g., static cling or electric charge). During the manufacturing process, for example, static electricity is created amongst and between the glass fibers. To reduce this static electricity, and the resulting issues with handling and packaging, an anti-static agent is often applied to the finished product (particularly with loose-fill fiberglass). In some embodiments, therefore, the timing and the amount of the anti-static application can be altered, or eliminated, to ensure adhesion of the pesticide (such as finely ground boric acid). In other embodiments, a mild electric field can be applied to the insulation during manufacture to enhance the static charge and thus, adhesion of the pesticide.

In still other embodiments, the pesticide may be introduced during the heating or cooling process to help adhere the pesticide to the glass fibers. In this manner, the pesticide can be introduced to the glass fibers when they are still in a molten, or semi-molten state, enabling the pesticide to be partially incorporated into the fibers. In some embodiments, the pesticide can be added using a surfactant or other additive or adhesive.

The pesticide can also be introduced to the fiberglass at many stages along the production process. In some embodiments, the pesticide can be sprayed onto the fiberglass as it travels along a conveyor, or other manufacturing apparatus. In other embodiments, the pesticide can be added in a forming chamber or curing oven.

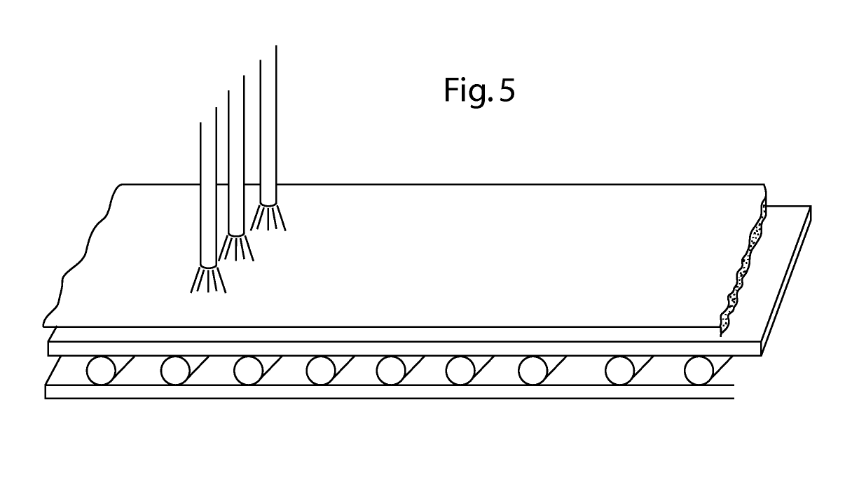

The pesticide can also be provided using a number of application methods. The pesticide can be introduced, for example, with an atomizer. In other embodiments, as shown in FIG. 5, the pesticide can be sprayed onto the glass fibers, in a liquid form, during manufacture. The pesticide can be applied to individual or groups of fibers prior to final forming (i.e., after they are spun or extruded, but before they are finally formed), for example, or can be applied to the fibers after they have been formed into batts or rolls.

In still other embodiments, the insulation can be dipped into a container of liquid or powdered pesticide. The liquid pesticide can subsequently dry and form a powder, film, or residue on the glass fibers that, once dried, would become “bio-available.” For use with “batted” insulation, for example, the product can be wrapped or encased in a material that has been treated or infused with a pesticide, such as a textile that has been infused with a pesticide; or the material encompassing the batted fiberglass (paper or poly) may be treated with the pesticide.

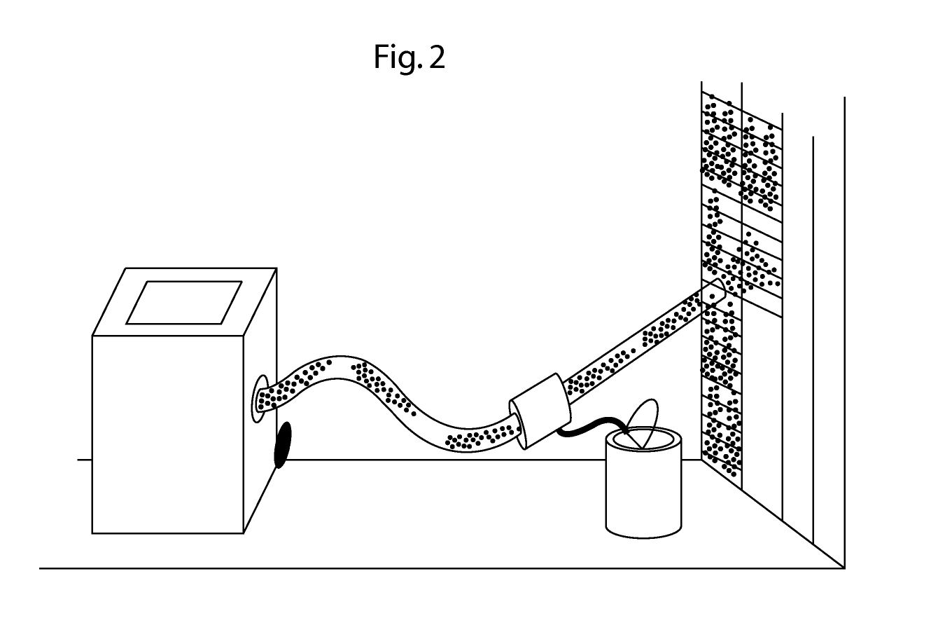

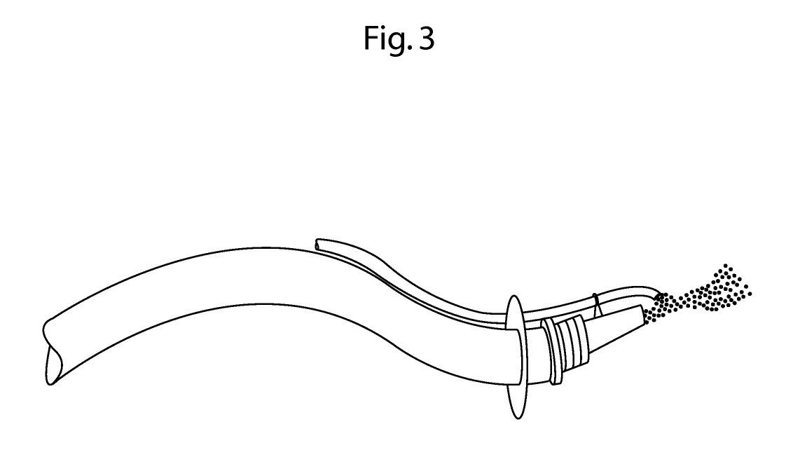

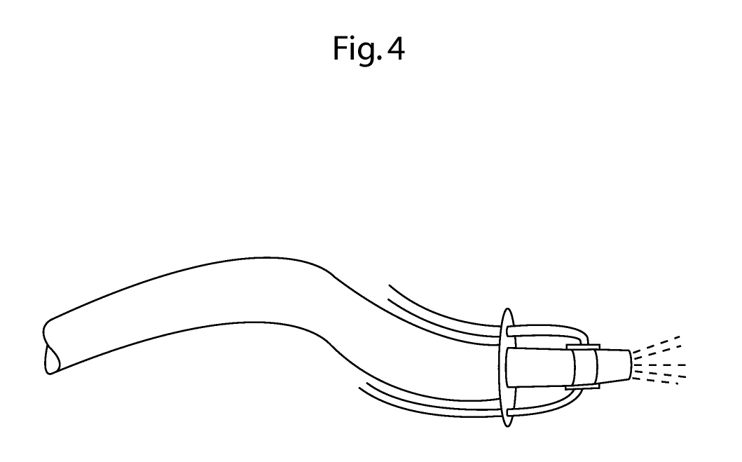

In some embodiments, the pesticide can be added during installation. As shown in FIG. 2, the pesticide can be introduced to a blown fiberglass (i.e. blowing wool) product, for example, at many points between the blowing machine and the end of the application hose that extends from the blowing machine. As shown in FIG. 3, the pesticide can also be introduced with a mechanism at the end of the application hose. As shown in FIG. 4, the pesticide can be in solid or liquid form and can be injected into the stream of insulation emitting from the blowing apparatus. The apparatus that injects the pesticide into the stream of insulation may also measure or otherwise condition the amount or quantity/quality of pesticide substance that is being introduced into the insulation.

In some embodiments, the installer can apply a liquid or solid pesticide to the insulation (batted, rolled, or loose fill) on the job site prior to installing the insulation. The pesticide can be sprayed onto the insulation, for example, or otherwise mixed with the insulation prior to installation.

While several possible embodiments are disclosed above, embodiments of the present invention are not so limited. For instance, insulation can be defined as any object that is placed in or on a structure (including buildings, airplanes, etc.), for example, for thermal, fire, or acoustical purposes. The final marketed “form” of the product could be, for example, in batts, rolls, or loose fill for blowing. Installing the product can be done, for example, by hand, with tools, rolled in, or pneumatically blown in place. The insulation system can be used in ceilings, suspended ceilings, walls, basements, crawl-spaces, or other voids or areas where insulation is traditionally applied, including those spaces on airplanes, ships, boats, etc. Similarly, several possible compounds are provided for pesticides, but myriad other pesticides exist and are contemplated herein.

The specific configurations, choice of materials and chemicals, and the size and shape of various elements can be varied according to particular design specifications or constraints requiring a system or method constructed according to the principles of the invention. For example, while certain exemplary ranges have been provided for the application of boric acid, for example, other concentrations can be used in conjunction with different pesticides or in different regions. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A system comprising:
insulation providing insulation for a predetermined portion of a structure; and
a pesticide adhered to the insulation product such that the pesticidal product is bioavailable;
wherein the system provides pest control at least for the predetermined portion of the structure.

2. The system of claim 1, wherein the predetermined portion of the structure comprises the thermal envelope of the structure; and
wherein the system provides pest control for the structure.

3. The system of claim 1, wherein the insulation comprises a plurality of glass fibers.

4. The system of claim 1, wherein the insulation comprises a plurality of glass fibers combined with one or more of cellulose, foam, rock wool, and cotton.

5. The system of claim 1, wherein the pesticide comprises boric acid.

6. The system of claim 5, wherein the pesticide comprises between 4-20% boric acid.

7. The system of claim 5, wherein the pesticide comprises 12.5% boric acid.

8. The system of claim 1, wherein the insulation provides one or more of thermal, fire, or acoustical insulation.

9. A method of manufacture comprising:
providing a plurality of glass fibers; and
applying a pesticide to the plurality of glass fibers such that the pesticide is bioavailable on the glass fibers.

10. The method of claim 9, further comprising:
heating the plurality of glass fibers until the plurality of glass fibers is at least partially molten prior to applying the pesticide to partially embed the pesticide in the glass fibers.

11. The method of claim 9, further comprising:
mixing the pesticide with a binder prior to applying the pesticide.

12. The method of claim 11, wherein the binder comprises one or more selected from the group consisting of phenolic resin, thermoplastic, thermosetting plastic, acrylic, or vinyl-acrylic.

13. The method of claim 9, wherein applying the pesticide to the plurality of glass fibers comprises dipping the plurality of glass fibers in the pesticide.

14. A method comprising:
filling a blowing apparatus with a plurality of glass fibers;
applying a pesticide to the plurality of glass fibers with the blowing apparatus; and
blowing the plurality of glass fibers into a structure to provide insulation;
wherein the plurality of glass fibers provide pest control for the structure.

15. The system of claim 14, wherein applying the pesticide to the plurality of glass fibers comprises mixing the plurality of glass fibers with the pesticide in a hopper of the blowing apparatus prior to blowing the plurality of glass fibers into the structure.

16. The system of claim 14, wherein applying the pesticide to the plurality of glass fibers comprises spraying the plurality of glass fibers with the pesticide using one or more nozzles located in a hose of the blowing apparatus prior to blowing the plurality of glass fibers into the structure.

17. The system of claim 14, wherein applying the pesticide to the plurality of glass fibers comprises spraying the plurality of glass fibers with the pesticide using one or more nozzles located at an outlet of a hose on the blowing apparatus as the glass fibers exit the blowing apparatus.
